(19) United States
(12) Patent Application Publication
(10) Pub. No.: US 2024/0140407 A1
(43) Pub. Date: May 2, 2024

(54) APPARATUS AND METHOD FOR CONTROLLING A VEHICLE

(71) Applicants: HYUNDAI MOTOR COMPANY, Seoul (KR); KIA CORPORATION, Seoul (KR)

(72) Inventor: Jae Il Park, Seoul (KR)

(73) Assignees: HYUNDAI MOTOR COMPANY, Seoul (KR); KIA CORPORATION, Seoul (KR)

(21) Appl. No.: 18/109,465

(22) Filed: Feb. 14, 2023

(30) Foreign Application Priority Data
Nov. 2, 2022 (KR) 10-2022-0144550

(51) Int. Cl. B60W 30/09; B60W 10/08; B60W 10/20

(52) U.S. Cl. CPC B60W 30/09; B60W 10/08; B60W 10/20; B60W 2510/205; B60W 2520/26; B60W 2552/05; B60W 2552/30; B60W 2710/08; B60W 2710/20

(57) ABSTRACT

An apparatus and method for controlling a vehicle are disclosed. The apparatus includes a controller and a sensor configured to obtain surrounding environment information and driving information of the vehicle. The controller is configured to divide, into one or more sections, a section of a road in which a steering change occurs corresponding to obstacle avoidance driving of the vehicle. The controller is configured to, when a collision with an obstacle is determined based on the surrounding environment information and the driving information, separately calculate a control amount for each section, among the one or more sections, according to a type of the road determine the type of the road by determining whether the vehicle is traveling on a straight road or a curved road based on the driving information.

### CROSS-REFERENCE TO RELATED APPLICATION

This application claims the benefit of and priority to Korean Patent Application No. 10-2022-0144550, filed in the Korean Intellectual Property Office on Nov. 2, 2022, the entire contents of which are incorporated herein by reference.

### TECHNICAL FIELD

The present disclosure relates to an apparatus and method for controlling a vehicle.

### BACKGROUND

When a risk of collision is detected while driving a vehicle, a driver inputs rotational force to a steering wheel to avoid the risk of collision. A vehicle is typically equipped with a control device for improving collision avoidance performance in a situation where the risk of collision is present. The control device is generally activated when the vehicle is driving on a straight section of a road.

However, when the vehicle is driving on a curved section of a road, vehicle behavior may become unstable, so that the control device is inactivated. Accordingly, on a curved section of a road, collision avoidance performance for avoiding the risk of collision is deteriorated and vehicle stability is not secured or maintained.

### SUMMARY

The present disclosure has been made to solve the above-mentioned problems occurring in the prior art while advantages achieved by the prior art are maintained intact.

An aspect of the present disclosure provides an apparatus and method for controlling a vehicle capable of maximizing collision risk avoidance performance during avoidance steering by a driver when a collision risk is detected in the front of the vehicle.

Another aspect of the present disclosure provides an apparatus and method for controlling a vehicle capable of controlling a driving motor not only when the vehicle is traveling in a straight section of the road but also when the vehicle is traveling in a curved section of the road and for calculating a control value for controlling a rear wheel steering of the vehicle, thereby securing vehicle stability.

Still another aspect of the present disclosure provides an apparatus and method for controlling a vehicle capable of increasing a yaw rate in an avoidance section of the road to increase an avoidance distance during avoidance steering by a driver, thereby improving avoidance performance.

Still another aspect of the present disclosure provides an apparatus and method for controlling a vehicle capable of reducing a yaw rate in a stable section after driving in an avoidance section, thereby improving vehicle stability after collision avoidance.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, an apparatus for controlling a vehicle includes a sensor configured to obtain surrounding environment information and driving information of the vehicle. The apparatus also includes a controller configured to divide, into one or more sections, a section of a road in which a steering change occurs corresponding to obstacle avoidance driving of the vehicle. The controller is also configured to, when a collision with an obstacle is determined based on the surrounding environment information and the driving information, separately calculate a control amount for each section, among the one or more sections, according to a type of the road. The controller is further configured to determine the type of the road by determining whether the vehicle is driving on a straight road or a curved road based on the driving information.

According to an embodiment, the controller may be configured to determine that the vehicle is traveling on the straight road when a steering angle included in the driving information is less than a first threshold value and a steering angular velocity is less than a second threshold value.

According to an embodiment, the controller may be configured to, when it is determined that the vehicle is traveling on a straight road, divide a section of the road in which the vehicle avoids the obstacle into a first avoidance section and a first stable section.

According to an embodiment, the controller may be configured to determine whether the vehicle is traveling in the first avoidance section based on the steering angle and the steering angular velocity.

According to an embodiment, the controller may be configured to calculate a control amount of a motor providing driving force of the vehicle and a control amount of a rear wheel steering device based on the driving information when it is determined that the vehicle travels in the first avoidance section, to control braking of the motor based on the calculated control amount, and to control the rear wheel steering device in inverse phase.

According to an embodiment, the controller may be configured to, when it is determined that the vehicle is traveling in the first avoidance section, determine whether the vehicle is traveling in the first stable section based on the steering angle, the steering angular velocity, and a rear wheel slip angle.

According to an embodiment, the controller may be configured to calculate a control amount of a motor providing driving force of the vehicle and a control amount of a rear wheel steering device based on the driving information when it is determined that the vehicle travels in the first stable section, control driving of the motor based on the calculated control amount, and control the rear wheel steering device in phase.

According to an embodiment, the controller may be configured to determine that the vehicle is traveling on the curved road when a steering angle included in the driving information exceeds a third threshold value greater than a first threshold value and is less than a fourth threshold value greater than the third threshold value, and when a steering angular velocity is less than a second threshold value.

According to an embodiment, the controller may be configured to, when it is determined that the vehicle is traveling on the curved road, divide the section of the road in which the vehicle avoids the obstacle into a second avoidance section, a second stable section, and a third stable section.

According to an embodiment, the controller may be configured to determine whether the vehicle is traveling in the second avoidance section based on the steering angle and the steering angular velocity.

According to an embodiment, the controller may be configured to calculate a control amount of a motor providing driving force of the vehicle based on the driving information, and to control braking of the motor based on the calculated control amount when it is determined that the vehicle travels in the second avoidance section.

According to an embodiment, the controller may be configured to, when it is determined that the vehicle is traveling in the second avoidance section, determine whether the vehicle is traveling in the second stable section based on the steering angle, the steering angular velocity, and a rear wheel slip angle.

According to an embodiment, the controller may be configured to calculate a control amount of a motor providing driving force of the vehicle, and to control driving of the motor based on the calculated control amount when it is determined that the vehicle travels in the second stable section.

According to an embodiment, the controller may be configured to, when it is determined that the vehicle is traveling in the second stable section, determine whether the vehicle is traveling in the third stable section based on whether a sign of the steering angle changes.

According to an embodiment, the controller may be configured to calculate the control amount of the motor providing the driving force of the vehicle and a control amount of a rear wheel steering device based on the driving information when it is determined that the vehicle travels in the third stable section, to control driving of the motor based on the calculated control amount, and to control the rear wheel steering device in phase.

According to another aspect of the present disclosure, a method of controlling a vehicle includes obtaining, by a sensor, surrounding environment information and driving information of the vehicle. The method also includes determining, by a controller, a type of a road on which the vehicle is traveling based on the driving information when a collision with an obstacle is determined based on the surrounding environment information and the driving information. The method further includes dividing, by the controller, a section in which a steering change occurs corresponding to obstacle avoidance driving into one or more sections. The method also includes separately calculating, by the controller, a control amount for each section, among the one or more sections, according to the type of the road.

According to an embodiment, the method may further include determining that the vehicle is traveling on a straight road when a steering angle included in the driving information is less than a first threshold value and a steering angular velocity is less than a second threshold value.

According to an embodiment, the method may further include, when it is determined that the vehicle is traveling on the straight road, dividing the section in which the vehicle avoids the obstacle into a first avoidance section and a first stable section.

According to an embodiment, the method may further include determining that the vehicle is traveling on a curved road when a steering angle included in the driving information exceeds a third threshold value greater than a first threshold value and is less than a fourth threshold value greater than the third threshold value, and when a steering angular velocity is less than a second threshold value.

According to an embodiment, the method may further include, when it is determined that the vehicle is traveling on the curved road, dividing the section in which the vehicle avoids the obstacle into a second avoidance section, a second stable section, and a third stable section.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating the configuration of an apparatus for controlling a vehicle according to an embodiment of the present disclosure;

FIG. 2 is a diagram schematically illustrating a steering change that occurs in response to obstacle avoidance driving while traveling on a straight road according to an embodiment of the present disclosure;

FIG. 3 is a diagram schematically illustrating a control amount of a motor when traveling on a straight road according to an embodiment of the present disclosure;

FIG. 4 is a diagram schematically illustrating a control amount of a rear wheel steering device when traveling on a straight road according to an embodiment of the present disclosure;

FIG. 5 is a diagram schematically illustrating a steering change generated in response to obstacle avoidance driving while traveling on a curved road according to an embodiment of the present disclosure;

FIG. 6 is a diagram schematically illustrating a control amount of a motor when traveling on a curved road according to an embodiment of the present disclosure;

FIG. 7 is a diagram schematically illustrating a control amount of a rear wheel steering device when traveling on a curved road according to an embodiment of the present disclosure;

FIG. 8 is a flowchart illustrating a method of controlling a vehicle according to an embodiment of the present disclosure;

FIG. 9 is a flowchart illustrating a method of controlling a vehicle according to another embodiment of the present disclosure; and

FIG. 10 is a block diagram illustrating a computing system for executing a method according to an embodiment of the present disclosure.

### DETAILED DESCRIPTION

Hereinafter, embodiments of the present disclosure are described in detail with reference to the accompanying drawings. In the accompanying drawings, identical or equivalent components are designated by the identical numerals even when they are displayed in different drawings. Further, if it has been considered that a specific description of related known configurations or functions may cloud the gist the present disclosure, a detailed description thereof has been omitted.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

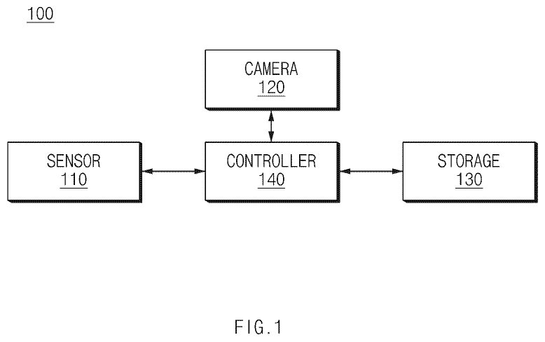

FIG. 1 is a block diagram illustrating configuration of an apparatus for controlling a vehicle according to an embodiment of the present disclosure.

As shown in FIG. 1, an apparatus 100 for controlling a vehicle according to an embodiment of the present disclosure may include a sensor 110, a camera 120, storage 130, and a controller 140.

The sensor 110 may be configured to obtain surrounding environment information and driving information of the vehicle.

According to an embodiment, the sensor 110 may obtain environment information including objects in front and sides of the vehicle. In embodiments, the sensor 110 may detect signals reflected from a preceding vehicle traveling in front of the vehicle, a road, a structure installed around the road, a vehicle approaching from an opposite lane, a line marking, and/or a road surface. In an embodiment, the sensor 110 may include a radar, a lidar, an ultrasonic sensor, or the like.

According to the embodiment, the sensor 110 may obtain the driving information of the vehicle. In an embodiment, the sensor 110 may obtain a wheel speed, a steering angle of a steering wheel, an accelerator pedal pressure level, a brake pedal pressure level, a yaw rate, a lateral acceleration, and a steering torque of a driver. The sensor 110 may include a vehicle speed sensor and a steering angle sensor, an acceleration pedal sensor, a brake pedal sensor, a yaw rate sensor, a steering torque sensor, and/or the like.

The camera 120 may be configured to obtain surrounding environment information of the vehicle.

According to an embodiment, the camera 120 may include a front camera for taking a front image of the vehicle and may include left and right side cameras for taking side views of the vehicle. The front camera may include a stereo camera and may obtain a distance to an obstacle in front of the vehicle based on information detected through the stereo image. In addition, the front camera may include a time-of-flight (TOF) camera and may obtain the distance to an obstacle in front of the vehicle based on the time until infrared rays or lasers emitted from a light source included in the camera are reflected and received by the obstacle.

The storage 130 may store at least one algorithm for performing operations or executions of various commands for the operation of an apparatus for controlling a vehicle according to an embodiment of the present disclosure. According to an embodiment, the storage 130 may include at least one storage medium of a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, or an optical disk.

The controller 140 may be implemented with various processing devices such as a microprocessor and the like in which a semiconductor chip capable of performing operations or executions of various commands is built-in and may control operations of the apparatus 100 for controlling a vehicle according to embodiments of the present disclosure. The controller 140 may be electrically connected to the sensor 110, the camera 120 and the storage 130 through a wired cable or various circuits to transfer an electrical signal including a control command and the like. The controller 140 may transmit and receive an electrical signal including a control command and the like through various wireless communication networks such as a controller area network (CAN).

The controller 140 may be configured to determine whether a collision with an obstacle is predicted based on the surrounding environment information of the vehicle and driving information of the vehicle. According to an embodiment, when the distance from the vehicle to an obstacle in front of the vehicle is less than a specified distance, the controller 140 may determine that a collision with the obstacle is predicted.

When determining that a collision between the vehicle and an obstacle is predicted, the controller 140 may determine whether the vehicle is traveling on a straight or curved road based on the steering angle information and steering angular velocity information obtained from the steering angle sensor. According to an embodiment, the controller 140 may obtain the steering angular velocity by differentiating and filtering the steering angle.

According to an embodiment, the controller 140 may determine that the collision between the vehicle and the obstacle is predicted and may determine that the vehicle is traveling on a straight road when the steering angle is less than a first threshold value and the steering angular velocity is less than a second threshold value.

According to an embodiment, the controller 140 may determine that the collision between the vehicle and the obstacle is predicted. The controller 140 may determine that the vehicle is traveling on a curved road when the steering angle exceeds a third threshold value greater than the first threshold value and is less than a fourth threshold value greater than the third threshold value and the steering angular velocity is less than the second threshold value.

Hereinafter, a control operation of the controller 140 in a state in which the vehicle is traveling on a straight road is first described.

When it is determined that the collision between the vehicle and the obstacle is predicted and the vehicle is traveling on a straight road, the controller 140 may determine whether the vehicle is traveling in a first avoidance section. In an embodiment of the present disclosure, the first avoidance section is a section in which the driver inputs steering to avoid an obstacle while driving on a straight road.

According to an embodiment, the controller 140 may determine whether the vehicle is traveling in the first avoidance section based on the steering angle and steering angular velocity obtained while traveling on a straight road. In an embodiment, the controller 140 may determine that the vehicle is traveling in the first avoidance section when the product of the steering angle and the steering angular velocity exceeds a fifth threshold value greater than 0 (zero).

When it is determined that the vehicle is not traveling in the first avoidance section while traveling on a straight road, the controller 140 may control the brake to decelerate the vehicle.

When it is determined that the vehicle is traveling in the first avoidance section while driving on a straight road, the controller 140 may calculate the lateral slip angle and the yaw acceleration value of the vehicle.

According to an embodiment, the lateral slip angle may include a front wheel slip angle and a rear wheel slip angle of the vehicle. The controller 140 may calculate the front wheel slip angle and rear wheel slip angle of a vehicle by using Equation 1 and Equation 2, respectively. The controller 140 may calculate the vehicle body slip angle of Equations 1 and 2 by using Equation 3.

Equation 1 for determining front wheel slip is as follows.

$${a}_{f} = {δ}_{f} - ( β + \frac{{l}_{f}}{{v}_{x}} γ ) \qquad < Equation 1 >$$

In Equation 1, a_{f} is the front wheel slip angle, δ_{f} is the front wheel steering angle, β is the vehicle body slip angle, l_{f} is the distance from vehicle center to front wheel, vₓ is the vehicle speed, γ is the yaw rate.

Equation 2 for determining rear wheel slip is as follows.

$${a}_{r} = {δ}_{r} + \frac{{l}_{r}}{{v}_{x}} γ - β \qquad < Equation 2 >$$

In Equation 2, aᵣ is the rear wheel slip angle, δᵣ is the rear wheel steering angle, β is the vehicle body slip angle, lᵣ is the distance from vehicle center to rear wheel, vₓ is the vehicle speed, and γ is the yaw rate.

Equation 3 for determining the vehicle body slip is follows.

$$β = \int ( \frac{{A}_{y}}{{v}_{x}} - γ ) dt \qquad < Equation 3 >$$

In Equation 3, β is the vehicle body slip angle, A_{y} is the lateral acceleration, vₓ=vehicle speed, and γ is the yaw rate.

In addition, the controller 140 may calculate a yaw acceleration value by using Equation 4.

$${Ψ}_{e s t} = \frac{d}{dt} ( ( \frac{{δ}_{f} * {v}_{x}}{L + {k}_{3} + {v}_{x}^{2}} ) \frac{1}{G} ) \qquad < Equation 4 >$$

In Equation 4, δ_{f} is the front wheel steering angle, vₓ is the vehicle speed, L is the wheelbase (distance between the center of the front wheel and the center of the rear wheel), G is the steering gear ratio, and k₃ is a weight.

When it is determined that the vehicle is traveling in the first avoidance section while traveling on a straight road, the controller 140 may determine whether the vehicle is traveling in a first stable section. In an embodiment of the present disclosure, the first stable section is a section in which the driver steers to avoid an obstacle and then steers again to return to a normal state.

According to an embodiment, the controller 140 may determine whether the vehicle is traveling in the first stable section based on the steering angle and steering angular velocity obtained while the vehicle is traveling in the first avoidance section. In an embodiment, when it is determined that (k₁*steering angle+k₂*steering angular velocity), where k1 and k2 are weights, exceeds a sixth threshold value and the rear wheel slip angle exceeds a seventh threshold value, the controller 140 may determine that the vehicle is traveling in the first stable section.

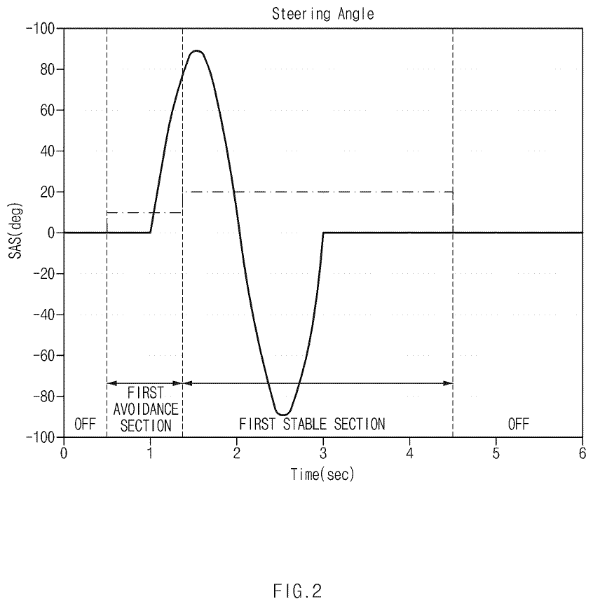

To improve avoidance performance for each of the first avoidance section and the first stable section while the vehicle is driving on a straight road, the controller 140 may calculate a control amount for controlling a motor and a rear wheel steering device to control the motor and the rear wheel control device. For more detailed description, refer to FIGS. 2 to 4.

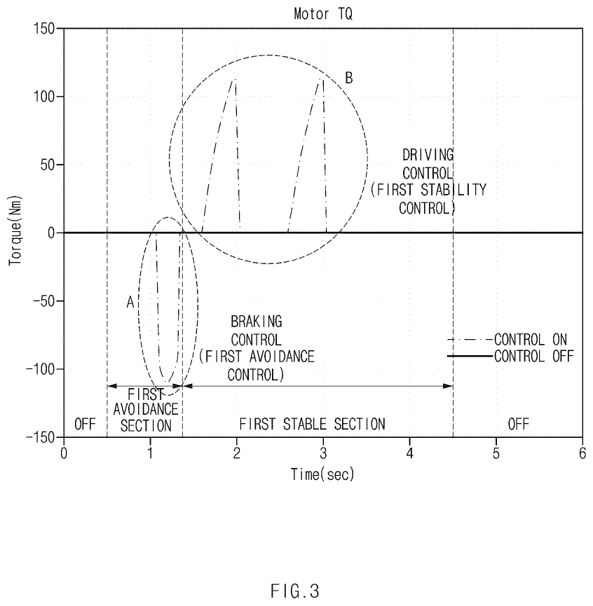

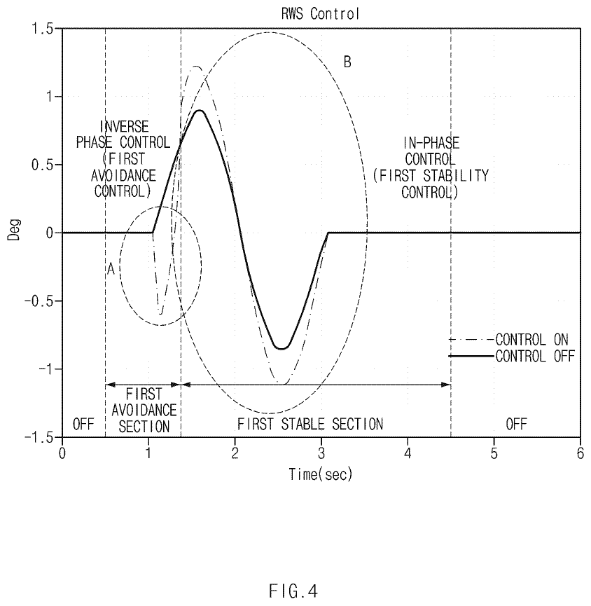

FIG. 2 is a diagram schematically illustrating a steering change that occurs in response to obstacle avoidance driving while traveling on a straight road, according to an embodiment of the present disclosure. FIG. 3 is a diagram schematically illustrating a control amount of a motor when traveling on a straight road, according to an embodiment of the present disclosure. FIG. 4 is a diagram schematically illustrating a control amount of a rear wheel steering device when traveling on a straight road, according to an embodiment of the present disclosure.

As shown in FIG. 2, the controller 140 may divide a section in which a steering change occurs corresponding to obstacle avoidance driving while the vehicle is traveling on a straight road into a first avoidance section and a first stable section according to the steering change.

In other words, the controller 140 may determine that the vehicle is traveling in the first avoidance section when the product of the steering angle and the steering angular velocity exceeds the fifth threshold value greater than 0 (zero). When it is determined that (k₁*steering angle+k₂*steering angular speed) exceeds the sixth threshold value and the rear wheel slip angle exceeds the seventh threshold value, the controller 140 may determine that the vehicle is traveling in the first stable section.

In order to improve obstacle avoidance performance in the first avoidance section, the controller 140 may calculate the control amount of a motor providing driving force of the vehicle and the control amount of a rear wheel steering (RWS) device based on driving information. The controller 140 may control braking of the motor and control the rear wheel steering device in inverse phase based on the calculated control amounts. In an embodiment, the inverse phase control may refer to a scheme of setting a steering sign of the rear wheel steering angle opposite to that of the front wheel steering angle and controlling the rear wheel steering device.

According to an embodiment, as shown in ‘A’ of FIG. 3, the controller 140 may calculate the control amount by multiplying the yaw acceleration value calculated by using Equation 4 by the weight k₄. The controller 140 may control the braking of the motor based on the calculated control amount. In an embodiment, the weight k₄ may be set as a tuning gain in the form of a map according to a vehicle speed.

According to an embodiment, as shown in ‘A’ of FIG. 4, the controller 140 may calculate the sum of the product of the front wheel slip angle calculated using Equation 1 and the weight k₆ and the product of the yaw acceleration value calculated using Equation 4 and the weight k₇ as the control amount. The controller 140 may control the rear wheel steering device in inverse phase based on the calculated control amount. In embodiment, the weights k₆ and k₇ may be set as tuning gains in the form of a map according to a vehicle speed.

In order to improve obstacle avoidance performance in the first stable section, the controller 140 may calculate the control amount of a motor providing driving force of the vehicle and the control amount of a rear wheel steering device based on the driving information. The controller 140 may control driving of the motor and the rear wheel steering device in phase based on the calculated control amounts. In an embodiment, the in-phase control may refer to a scheme of setting the steering sign of the rear wheel steering angle to be the same as that of the front wheel steering angle and controlling the rear wheel steering device.

According to an embodiment, as shown in ‘B’ of FIG. 3, the controller 140 may calculate the control amount by multiplying the yaw acceleration value calculated by using Equation 4 by a weight k₅ and control the driving of the motor based on the calculated control amount. In an embodiment, the weight k₅ may be set as a tuning gain in the form of a map according to a vehicle speed.

According to an embodiment, as shown in ‘B’ of FIG. 4, the controller 140 may calculate the sum of i) the product of the front wheel slip angle calculated using Equation 1 and the weight k₈ and ii) the product of the yaw acceleration value calculated using Equation 4 and the weight k₉ as the control amount. The controller 140 may control the rear wheel steering device based on the calculated control amount. In an embodiment, the weights k₈ and k₉ may be set as tuning gains in the form of a map according to a vehicle speed.

After the first stability control, the controller 140 may determine whether the first stability control is in an end state based on the steering angle, steering angular velocity, and yaw rate.

In an embodiment, when it is determined that the product of the steering angle and the steering angular velocity is equal to or less than the fifth threshold value greater than 0 (zero) and the time for which the yaw rate of the vehicle is maintained below an eighth threshold value is maintained for a specified time or more, the controller 140 may determine that the first stability control is terminated.

Next, a control operation of the controller 140 in a state in which the vehicle is traveling on a curved road is described.

When it is determined that the collision between the vehicle and the obstacle is predicted and the vehicle is traveling on a curved road, the controller 140 may determine whether the vehicle is traveling in a second avoidance section. In an embodiment of the present disclosure, the second avoidance section is a section in which the driver steers to avoid an obstacle while driving on a curved road.

According to an embodiment, the controller 140 may determine whether the vehicle is traveling in the second avoidance section based on the steering angle and steering angular velocity obtained while traveling on a curved road. In an embodiment, the controller 140 may determine that the vehicle is traveling in the second avoidance section when the product of the steering angle and the steering angular velocity exceeds the fifth threshold value greater than 0 (zero).

When it is determined that the vehicle is not traveling in the second avoidance section while traveling on a curved road, the controller 140 may control the brake to decelerate the vehicle.

When it is determined that the vehicle is traveling in the second avoidance section while driving on a curved road, the controller 140 may calculate the lateral slip angle and the yaw acceleration value of the vehicle.

According to an embodiment, the lateral slip angle may include a front wheel slip angle and a rear wheel slip angle of a vehicle The controller 140 may calculate the front wheel slip angle and rear wheel slip angle of a vehicle by using Equation 1 and Equation 2, respectively. In addition, the controller 140 may calculate the yaw acceleration value by using Equation 4.

When it is determined that the vehicle is traveling in the second avoidance section while traveling on a curved road, the controller 140 may determine whether the vehicle is traveling in a second stable section. When it is determined that the vehicle is traveling in the second stable section, the controller 140 may determine whether the vehicle is traveling in a third stable section. In an embodiment of the present disclosure, the second and third stable sections are sections in which the driver steers to avoid an obstacle and then steers again to return to a normal state.

In an embodiment of the present disclosure, when the rear wheel control device is controlled by suddenly increasing the yaw rate and lateral acceleration in a situation where the steering angle is increased due to driving on a curved road, because abnormality in vehicle behavior may occur, it is possible to maximize the avoidance performance stably by dividing the section in which the driver steers to avoid an obstacle and then steers again to return to the normal state into the second stable section and the third stable section and calculating the control amount for each section.

According to an embodiment, the controller 140 may determine whether the vehicle is traveling in the second stable section based on the steering angle and steering angular velocity obtained while traveling in the second avoidance section. In an embodiment, when it is determined that (k₁*steering angle+k₂*steering angular velocity) exceeds the sixth threshold value and the rear wheel slip angle exceeds the seventh threshold value, the controller 140 may determine that the vehicle is traveling in the second stable section.

The controller 140 may determine whether the vehicle is traveling in the third stable section after determining that the vehicle is traveling in the second stable section.

According to an embodiment, the controller 140 may determine that the vehicle is traveling in the third stable section when it is determined that the sign of the steering angle is changed while traveling in the second stable section.

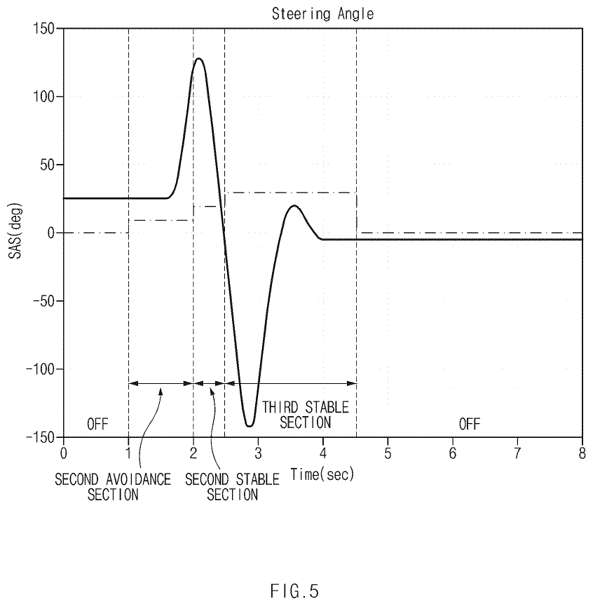

To improve avoidance performance for each of the second avoidance section, the second stable section, and the third stable section while the vehicle is traveling on a curved road, the controller 140 may calculate a control amount for controlling a motor and a rear wheel steering device and control the motor and the rear wheel control device based on the control amount. For more detailed description, refer to FIGS. 5 to 7.

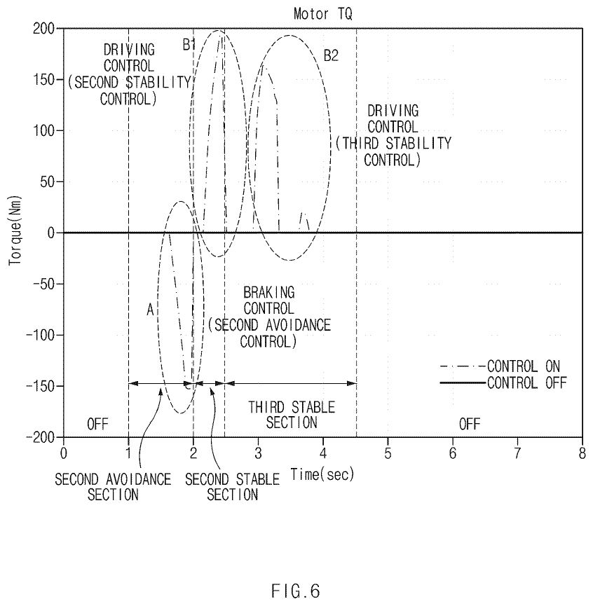

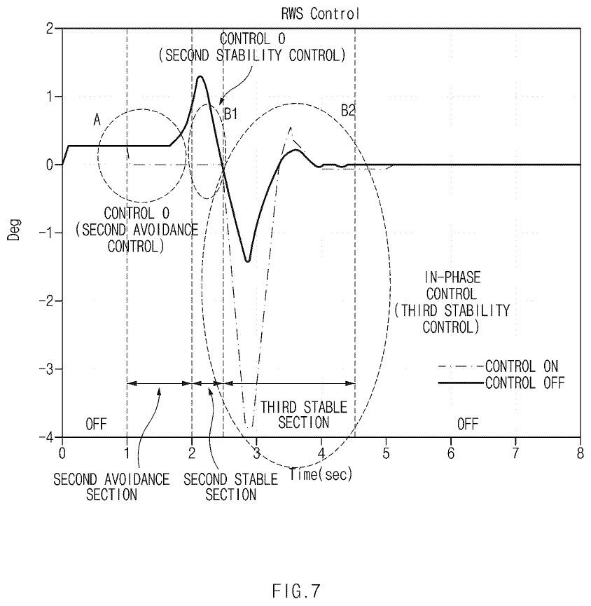

FIG. 5 is a diagram schematically illustrating a steering change generated in response to obstacle avoidance driving while traveling on a curved road, according to an embodiment of the present disclosure. FIG. 6 is a diagram schematically illustrating a control amount of a motor when traveling on a curved road, according to an embodiment of the present disclosure. FIG. 7 is a diagram schematically illustrating a control amount of a rear wheel steering device when traveling on a curved road, according to an embodiment of the present disclosure.

As shown in FIG. 5, the controller 140 may divide a section in which a steering change occurs corresponding to obstacle avoidance driving while the vehicle is traveling on a curved road into a second avoidance section, a second stable section and a third stable section according to the steering change.

In an embodiment, the controller 140 may determine that the vehicle is traveling in the second avoidance section when the product of the steering angle and the steering angular velocity exceeds the fifth threshold value greater than 0 (zero). When it is determined that (k₁*steering angle+k₂*steering angular speed) exceeds the sixth threshold value and the rear wheel slip angle exceeds the seventh threshold value, the controller 140 may determine that the vehicle is traveling in the second stable section. In addition, when it is determined that the sign of the steering angle is changed, the controller 140 may determine that the vehicle is traveling in the third stable section.

In order to improve obstacle avoidance performance in the second avoidance section, the controller 140 may calculate the control amount of a motor providing driving force of the vehicle based on driving information, control braking of the motor based on the calculated control amount, and maintain the control amount of the rear wheel control device at 0 (zero) to maintain the behavior of the vehicle.

According to an embodiment, as shown in ‘A’ of FIG. 6, the controller 140 may calculate the control amount by multiplying the yaw acceleration value calculated by using Equation 4 by a weight k₁₀. The controller 140 may control the driving of the motor based on the calculated control amount. In an embodiment, the weight k₁₀ may be set as a tuning gain in the form of a map according to a vehicle speed.

According to an embodiment, as shown in ‘A’ of FIG. 7, the controller 140 may control the rear wheel control device by setting the control amount to 0 to maintain the behavior of the vehicle.

In order to improve obstacle avoidance performance in the second stable section, the controller 140 may calculate the control amount of a motor providing driving force of the vehicle based on the driving information. The controller 140 may control braking of the motor based on the calculated control amounts. In addition, the controller 140 may maintain the control amount of the rear wheel control device at 0 (zero) to maintain the behavior of the vehicle.

According to an embodiment, as shown in ‘B1’ of FIG. 6, the controller 140 may calculate the control amount by multiplying the yaw acceleration value calculated by using Equation 4 by a weight k₁₁. The controller 140 may control the driving of the motor based on the calculated control amount. In an embodiment, the weight k₁₁ may be set as a tuning gain in the form of a map according to a vehicle speed.

According to an embodiment, as shown in ‘B1’ of FIG. 7, the controller 140 may control the rear wheel control device by setting the control amount to 0 (zero) to maintain the behavior of the vehicle.

In order to improve obstacle avoidance performance in the third stable section, the controller 140 may calculate the control amount of a motor providing driving force of the vehicle and the control amount of a rear wheel steering device based on the driving information. The controller 140 may control driving of the motor and the rear wheel steering device in phase based on the calculated control amounts. In an embodiment, the in-phase control may refer to a scheme of setting the steering sign of the rear wheel steering angle to be the same as that of the front wheel steering angle and controlling the rear wheel steering device.

According to an embodiment, as shown in ‘B2’ of FIG. 6, the controller 140 may calculate the control amount by multiplying the yaw acceleration value calculated by using Equation 4 by a weight k₁₂. The controller 140 may control the driving of the motor based on the calculated control amount. In an embodiment, the weight k₁₂ may be set as a tuning gain in the form of a map according to a vehicle speed.

According to an embodiment, as shown in ‘B2’ of FIG. 7, the controller 140 may calculate the sum of i) the product of the front wheel slip angle calculated using Equation 1 and the weight k₁₃ and ii) the product of the yaw acceleration value calculated using Equation 4 and the weight k₁₄ as the control amount. The controller 140 may control the rear wheel steering device based on the calculated control amount. In an embodiment, the weights k₁₃ and k₁₄ may be set as tuning gains in the form of a map according to a vehicle speed.

After the third stability control, the controller 140 may determine whether the third stability control is in an end state based on the steering angle, steering angular velocity, and yaw rate.

In an embodiment, when it is determined that the product of the steering angle and the steering angular velocity is equal to or less than the fifth threshold value greater than 0 (zero) and the time for which the yaw rate of the vehicle is maintained below the eighth threshold value is maintained for a specified time or more, the controller 140 may determine that the third stability control is terminated.

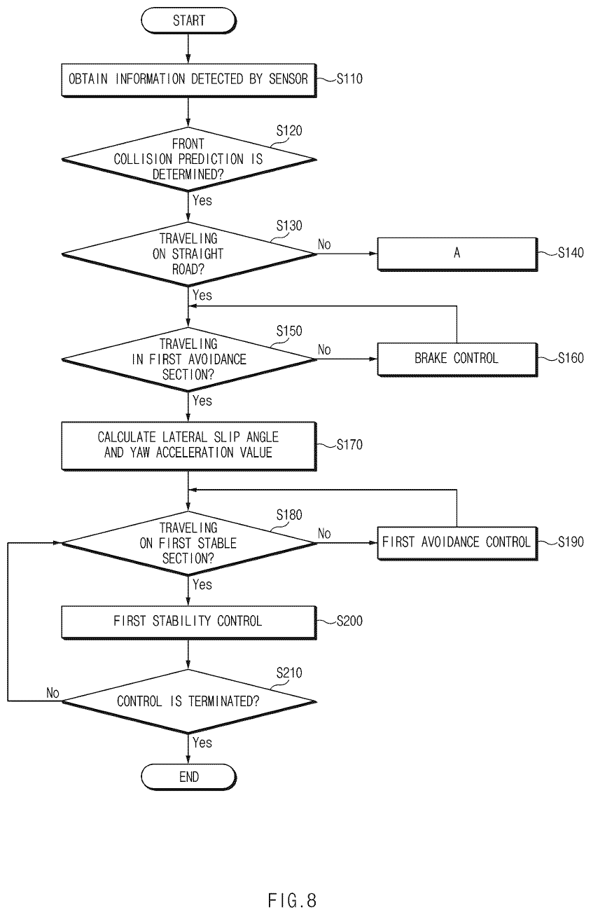

FIG. 8 is a flowchart illustrating a method of controlling a vehicle, according to an embodiment of the present disclosure.

As shown in FIG. 8, in operation S110, the controller 140 may obtain surrounding environment information of the vehicle and driving information of the vehicle detected by the sensor 110.

In operation S120, the controller 140 may determine whether a collision with an obstacle is predicted based on the information obtained in operation S110.

According to an embodiment, in operation S120, the controller 140 may determine that a collision with an obstacle is predicted when the distance from the vehicle to the obstacle in front of the vehicle is less than a specified distance.

When it is determined that a collision between the vehicle and the obstacle is predicted, in operation S130, the controller 140 may determine whether the vehicle is traveling on a straight road based on steering angle information and steering angular velocity information obtained through a steering angle sensor.

According to an embodiment, the controller 140 may determine that the collision between the vehicle and the obstacle is predicted in operation S130. The controller 140 may determine that the vehicle is traveling on a straight road when the steering angle is less than a first threshold value and the steering angular velocity is less than a second threshold value.

When determining that the vehicle is not traveling on a straight road, the controller 140 may perform operation S140.

When it is determined that the collision between the vehicle and the obstacle is predicted and the vehicle is traveling on a straight road, in operation S150, the controller 140 may determine whether the vehicle is traveling in a first avoidance section. In operation S150, the first avoidance section may be a section in which the driver steers to avoid an obstacle while driving on a straight road.

According to an embodiment, in operation S150, the controller 140 may determine whether the vehicle is traveling in the first avoidance section based on the steering angle and steering angular velocity obtained while traveling on a straight road. In an embodiment, the controller 140 may determine that the vehicle is traveling in the first avoidance section when the product of the steering angle and the steering angular velocity exceeds the fifth threshold value greater than 0 (zero).

When it is determined that the vehicle is not traveling in the first avoidance section while traveling on a straight road, in operation S160, the controller 140 may control the brake to decelerate the vehicle.

When it is determined that the vehicle is traveling in the first avoidance section while driving on a straight road, in operation S170, the controller 140 may calculate the lateral slip angle and the yaw acceleration value of the vehicle.

According to an embodiment, the lateral slip angle may include a front wheel slip angle and a rear wheel slip angle of a vehicle. The controller 140 may calculate the front wheel slip angle and rear wheel slip angle of a vehicle by using Equation 1 and Equation 2, respectively. The controller 140 may calculate the vehicle body slip angle of Equations 1 and 2 by using Equation 3. The controller 140 may calculate a yaw acceleration value by using Equation 4.

When it is determined that the vehicle is traveling in the first avoidance section while traveling on a straight road, in operation S180, the controller 140 may determine whether the vehicle is traveling in a first stable section. In S180, the first stable section may be a section in which the driver steers to avoid an obstacle and then steers again to return to a normal state.

According to an embodiment, in operation S180, the controller 140 may determine whether the vehicle is traveling in the first stable section based on the steering angle and steering angular velocity obtained while traveling in the first avoidance section. In an embodiment, when it is determined that (k₁*steering angle+k₂*steering angular velocity) exceeds a sixth threshold value and the rear wheel slip angle exceeds a seventh threshold value, the controller 140 may determine that the vehicle is traveling in the first stable section.

When it is determined in operation S180 that the vehicle is not traveling in the first stable section, in operation S190, the controller 140 may perform a first avoidance control. In operation S190, the first avoidance control may include i) an operation of calculating a control amount for controlling a motor and a rear wheel steering device of the vehicle to improve avoidance performance when the vehicle is traveling in the first avoidance section and ii) an operation of controlling the motor and the rear wheel control device based on the control amount.

According to an embodiment, the controller 140 may calculate the control amount by multiplying the yaw acceleration value calculated by using Equation 4 by the weight k₄. The controller 140 may control the braking of the motor based on the calculated control amount. In an embodiment, the weight k₄ may be set as a tuning gain in the form of a map according to a vehicle speed.

According to an embodiment, in operation S190, the controller 140 may calculate the sum of i) the product of the front wheel slip angle calculated using Equation 1 and the weight k₆ and ii) the product of the yaw acceleration value calculated using Equation 4 and the weight k₇ as the control amount. The controller 140 may control the rear wheel steering device in inverse phase based on the calculated control amount. In an embodiment, the weights k₆ and k₇ may be set as tuning gains in the form of a map according to a vehicle speed.

When it is determined in operation S180 that the vehicle is traveling in the first stable section, the controller 140 may perform a first stability control in operation S200. In operation S200, the first stability control may include i) an operation of calculating a control amount for controlling the motor and the rear wheel steering device to improve avoidance performance when the vehicle is traveling in the first stable section and ii) an operation of controlling the motor and the rear wheel control device based on the control amount.

According to an embodiment, in operation S200, the controller 140 may calculate the control amount by multiplying the yaw acceleration value calculated by using Equation 4 by a weight k₅ The controller 140 may control the driving of the motor based on the calculated control amount. In an embodiment, the weight k₅ may be set as a tuning gain in the form of a map according to a vehicle speed.

According to an embodiment, in operation S200, the controller 140 may calculate the sum of i) the product of the front wheel slip angle calculated using Equation 1 and the weight k₈ and ii) the product of the yaw acceleration value calculated using Equation 4 and the weight k₉ as the control amount. The controller 140 may control the rear wheel steering device based on the calculated control amount. In an embodiment, the weights k₈ and k₉ may be set as tuning gains in the form of a map according to a vehicle speed.

After the first stability control, in operation S210, the controller 140 may determine whether the first stability control is in an end state based on the steering angle, steering angular velocity, and yaw rate.

In an embodiment, when it is determined that the product of the steering angle and the steering angular velocity is equal to or less than a fifth threshold value greater than 0 (zero) and the yaw rate of the vehicle is maintained below an eighth threshold value for a specified time or more, the controller 140 may determine that the first stability control is terminated.

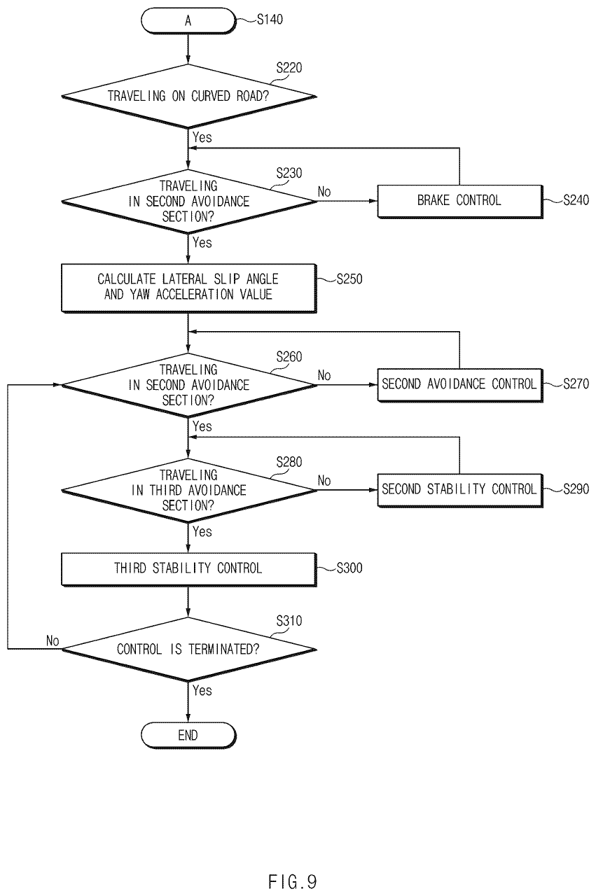

FIG. 9 is a flowchart illustrating a method of controlling a vehicle, according to another embodiment of the present disclosure.

After operation S140 of FIG. 8, the controller 140 may determine whether the vehicle is traveling on a curved road in operation S220.

According to an embodiment, in operation S220, the controller 140 may determine that the collision between the vehicle and the obstacle is predicted and determine that the vehicle is traveling on a curved road when i) the steering angle exceeds a third threshold value greater than the first threshold value and is less than a fourth threshold value greater than the third threshold value and ii) the steering angular velocity is less than the second threshold value.

When it is determined that the collision between the vehicle and the obstacle is predicted and the vehicle is traveling on a curved road, in operation S230, the controller 140 may determine whether the vehicle is traveling in a second avoidance section. In operation S230, the second avoidance section may be a section in which the driver inputs steering to avoid an obstacle while driving on a curved road.

According to an embodiment, in operation S230, the controller 140 may determine whether the vehicle is traveling in the second avoidance section based on the steering angle and steering angular velocity obtained while traveling on a curved road. In an embodiment, the controller 140 may determine that the vehicle is traveling in the second avoidance section when the product of the steering angle and the steering angular velocity exceeds a fifth threshold value greater than 0 (zero).

When it is determined that the vehicle is not traveling in the second avoidance section while traveling on a straight road, in operation S240, the controller 140 may control the brake to decelerate the vehicle.

When it is determined that the vehicle is traveling in the second avoidance section while driving on a curved road, in operation S250, the controller 140 may calculate the lateral slip angle and the yaw acceleration value of the vehicle.

According to an embodiment, in operation S250, the lateral slip angle may include a front wheel slip angle and a rear wheel slip angle of a vehicle. The controller 140 may calculate the front wheel slip angle and rear wheel slip angle of a vehicle by using Equation 1 and Equation 2, respectively. In addition, the controller 140 may calculate the yaw acceleration value by using Equation 4.

When it is determined that the vehicle is traveling in the second avoidance section while traveling on a curved road, in operation S260, the controller 140 may determine whether the vehicle is traveling in a second stable section. In operation S260, the second stable section may be a section in which the driver steers to avoid an obstacle and then steers again to return to a normal state.

According to an embodiment, in operation S260, the controller 140 may determine whether the vehicle is traveling in the second stable section based on the steering angle and steering angular velocity obtained while traveling in the second avoidance section. In an embodiment, when it is determined that (k₁*steering angle+k₂*steering angular velocity) exceeds the sixth threshold value and the rear wheel slip angle exceeds the seventh threshold value, the controller 140 may determine that the vehicle is traveling in the second stable section.

When it is determined in operation S260 that the vehicle is not traveling in the second stable section, in operation S270, the controller 140 may perform a second avoidance control. In operation S270, the second avoidance control may include i) an operation of calculating a control amount for controlling the motor and the rear wheel steering device to improve avoidance performance when the vehicle is traveling in the second avoidance section and ii) an operation of controlling the motor and the rear wheel control device based on the control amount.

According to an embodiment, in operation S270, the controller 140 may calculate the control amount by multiplying the yaw acceleration value calculated by using Equation 4 by a weight k₁₀. The controller 140 may control the driving of the motor based on the calculated control amount. In an embodiment, the weight k₁₀ may be set as a tuning gain in the form of a map according to a vehicle speed.

According to an embodiment, in operation S270, the controller 140 may control the rear wheel control device by setting the control amount to 0 (zero) to maintain the behavior of the vehicle.

When it is determined in operation S260 that the vehicle is traveling in the second stable section, in operation S280, the controller 140 may determine whether the vehicle is traveling in a third stable section. In operation S280, it is the third stable section may be a section in which the driver steers to avoid an obstacle and then steers again to return to a normal state.

According to an embodiment, the controller 140 may determine that the vehicle is traveling in the third stable section when it is determined in operation S280 that the sign of the steering angle is changed while traveling in the second stable section.

When it is determined in operation S280 that the vehicle is not traveling in the third stable section, the controller 140 may perform a second stability control in operation S290. In operation S290, the second stability control may include i) an operation of calculating a control amount for controlling the motor and the rear wheel steering device to improve avoidance performance when the vehicle is traveling in the second stable section and ii) an operation of controlling the motor and the rear wheel control device based on the control amount.

According to an embodiment, in operation S290, the controller 140 may calculate the control amount by multiplying the yaw acceleration value calculated by using Equation 4 by a weight k₁₁. The controller 140 may control the driving of the motor based on the calculated control amount. In an embodiment, the weight k₁₁ may be set as a tuning gain in the form of a map according to a vehicle speed.

According to an embodiment, in operation S290, the controller 140 may control the rear wheel control device by setting the control amount to 0 (zero) to maintain the behavior of the vehicle.

When it is determined in operation S280 that the vehicle is traveling in the third stable section, the controller 140 may perform a third stability control in operation S300. In operation S300, the third stability control may include i) an operation of calculating a control amount for controlling the motor and the rear wheel steering device to improve avoidance performance when the vehicle is traveling in the third stable section and ii) an operation of controlling the motor and the rear wheel control device based on the control amount.

According to an embodiment, in operation S300, the controller 140 may calculate the control amount by multiplying the yaw acceleration value calculated by using Equation 4 by a weight k₁₂. The controller 140 may control the driving of the motor based on the calculated control amount. In an embodiment, the weight k₁₂ may be set as a tuning gain in the form of a map according to a vehicle speed.

According to an embodiment, in operation S300, the controller 140 may calculate the sum of i) the product of the front wheel slip angle calculated using Equation 1 and the weight k₁₃ and ii) the product of the yaw acceleration value calculated using Equation 4 and the weight k₁₄ as the control amount. The controller 140 may control the rear wheel steering device based on the calculated control amount. In an embodiment, the weights k₁₃ and k₁₄ may be set as tuning gains in the form of a map according to a vehicle speed.

After the third stability control, in operation S310, the controller 140 may determine whether the third stability control is in an end state based on the steering angle, steering angular velocity, and yaw rate.

In embodiment, when it is determined that the product of the steering angle and the steering angular velocity is equal to or less than the fifth threshold value greater than 0 (zero) and the yaw rate of the vehicle is maintained below the eighth threshold value for a specified time or more, the controller 140 may determine that the third stability control is terminated.

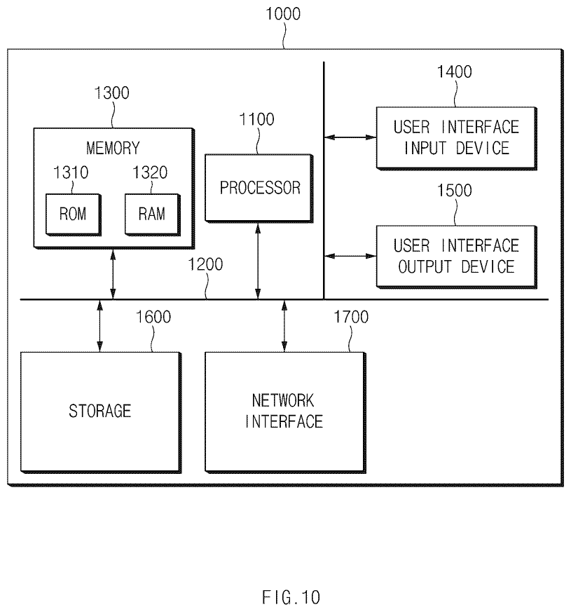

FIG. 10 is a block diagram illustrating a computing system for executing a method according to an embodiment of the present disclosure.

Referring to FIG. 10, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. In embodiments, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (e.g., the memory 1300 and/or the storage 1600), such as a RAM, a flash memory, a ROM, an EPROM, an EEPROM, a register, a hard disk, solid state drive (SSD), a detachable disk, or a CD-ROM. The storage medium may be coupled to the processor 1100 and the processor 1100 may read information from the storage medium and may write information in the storage medium. In another embodiment, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the embodiments of the present disclosure, an apparatus and a method for controlling a vehicle can maximize avoidance performance and secure vehicle stability by calculating and controlling a control value for controlling a drive motor and a control value for controlling rear wheel steering in a straight section of a road and a curved section of a road when a collision risk is detected.

Although embodiments of the present disclosure have been described for illustrative purposes, those having ordinary skill in the art should appreciate that various modifications, additions and substitutions are possible, without departing from the scope and spirit of the disclosure.

Therefore, the embodiments described in the present disclosure are provided for the sake of descriptions, not limiting the technical concepts of the present disclosure. It should be understood that such embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for controlling a vehicle, the apparatus comprising:
a sensor configured to obtain surrounding environment information and driving information of the vehicle; and
a controller configured to
divide, into one or more sections, a section of a road in which the vehicle is traveling and in which a steering change occurs due to obstacle avoidance driving of the vehicle, and
when a collision with an obstacle is determined based on the surrounding environment information and the driving information, separately calculate a control amount for each section, among the one or more sections, according to a type of the road, and determine the type of the road by determining whether the vehicle is traveling on a straight road or a curved road based on the driving information.

2. The apparatus of claim 1, wherein the controller is configured to determine that the vehicle is traveling on the straight road when a steering angle included in the driving information is less than a first threshold value and when a steering angular velocity is less than a second threshold value.

3. The apparatus of claim 2, wherein the controller is configured to, when it is determined that the vehicle is traveling on the straight road, divide a section of the road in which the vehicle avoids the obstacle into a first avoidance section and a first stable section.

4. The apparatus of claim 3, wherein the controller is configured to determine whether the vehicle is traveling in the first avoidance section based on the steering angle and the steering angular velocity.

5. The apparatus of claim 4, wherein the controller is configured to
calculate a control amount of a motor providing driving force of the vehicle and a control amount of a rear wheel steering device based on the driving information when it is determined that the vehicle travels in the first avoidance section,
control braking of the motor based on the calculated control amount, and
control the rear wheel steering device in inverse phase.

6. The apparatus of claim 4, wherein the controller is configured to, when it is determined that the vehicle is traveling in the first avoidance section, determine whether the vehicle is traveling in the first stable section based on the steering angle, the steering angular velocity, and a rear wheel slip angle.

7. The apparatus of claim 6, wherein the controller is configured to
when it is determined that the vehicle is traveling in the first stable section, calculate the control amount of the motor providing driving force of the vehicle and the control amount of the rear wheel steering device based on the driving information,
control driving of the motor based on the calculated control amount, and
control the rear wheel steering device in phase.

8. The apparatus of claim 1, wherein the controller is configured to determine that the vehicle is traveling on the curved road when a steering angle included in the driving information exceeds a third threshold value greater than a first threshold value and is less than a fourth threshold value greater than the third threshold value and when a steering angular velocity is less than a second threshold value.

9. The apparatus of claim 8, wherein the controller is configured to, when it is determined that the vehicle is traveling on the curved road, divide the section in which the vehicle avoids the obstacle into a second avoidance section, a second stable section, and a third stable section.

10. The apparatus of claim 9, wherein the controller is configured to determine whether the vehicle is traveling in the second avoidance section based on the steering angle and the steering angular velocity.

11. The apparatus of claim 10, wherein the controller is configured to
calculate a control amount of a motor providing driving force of the vehicle based on the driving information, and
control braking of the motor based on the calculated control amount when it is determined that the vehicle travels in the second avoidance section.

12. The apparatus of claim 10, wherein the controller is configured to, when it is determined that the vehicle is traveling in the second avoidance section, determine whether the vehicle is traveling in the second stable section based on the steering angle, the steering angular velocity, and a rear wheel slip angle.

13. The apparatus of claim 12, wherein the controller is configured to
calculate the control amount of the motor providing driving force of the vehicle, and
control driving of the motor based on the calculated control amount when it is determined that the vehicle travels in the second stable section.

14. The apparatus of claim 13, wherein the controller is configured to, when it is determined that the vehicle is traveling in the second stable section, determine whether the vehicle is traveling in the third stable section based on whether a sign of the steering angle changes.

15. The apparatus of claim 14, wherein the controller is configured to
calculate the control amount of the motor providing the driving force of the vehicle and the control amount of the rear wheel steering device based on the driving information when it is determined that the vehicle travels in the third stable section,
control driving of the motor based on the calculated control amount, and
control the rear wheel steering device in phase.

16. A method of controlling a vehicle, the method comprising:
obtaining, by a sensor, surrounding environment information and driving information of the vehicle;
determining, by a controller, a type of a road on which the vehicle is traveling based on the driving information when a collision with an obstacle is determined based on the surrounding environment information and the driving information;
dividing, by the controller, a section of the road in which a steering change occurs corresponding to obstacle avoidance driving into one or more sections; and
separately calculating, by the controller, a control amount for each section, among the one or more sections, according to the type of the road.

17. The method of claim 16, further comprising determining that the vehicle is traveling on a straight road when a steering angle included in the driving information is less than a first threshold value and a steering angular velocity is less than a second threshold value.

18. The method of claim 17, further comprising, when it is determined that the vehicle is traveling on the straight road, dividing the section in which the vehicle avoids the obstacle into a first avoidance section and a first stable section.

19. The method of claim 16, further comprising determining that the vehicle is traveling on a curved road when a steering angle included in the driving information exceeds a third threshold value greater than a first threshold value and is less than a fourth threshold value greater than the third threshold value and when a steering angular velocity is less than a second threshold value.

20. The method of claim 19, further comprising, when it is determined that the vehicle is traveling on the curved road, dividing the section in which the vehicle avoids the obstacle into a second avoidance section, a second stable section, and a third stable section.
